(19) United States
(12) Patent Application Publication
(10) Pub. No.: US 2006/0080641 A1
(43) Pub. Date: Apr. 13, 2006

(54) Inferring data type in a multi stage process

(75) Inventors: Richard Taylor, Bristol (GB); Christopher Tofts, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P.

(21) Appl. No.: 11/178,135

(22) Filed: Jul. 8, 2005

(30) Foreign Application Priority Data
Jul. 10, 2004 (GB) 0415466.2

(51) Int. Cl. G06F 9/44

(52) U.S. Cl. 717/126

(57) ABSTRACT

A computer program (10) for analysing a specification, determining what kind of data processing operations are carried out, and deducing or inferring from the kind of internal operations, what data types are appropriate. The data types inferred can be compared with specified data types, to check for errors, or optimise the overall process. This is effectively an extension of type inference from individual programs into the higher level technical field of process analysis. It can also be applied to monitoring and optimising processes during operation of the processes.

### FIELD OF THE INVENTION

The invention relates to the field of methods of analysing specifications of multi stage processes, to check, or optimise such processes, or for other purposes, to programs or systems arranged to carry out such analysis, to processes described by specifications subjected to such analysis, to templates for such processes, and to programs for analysing such processes in use.

### BACKGROUND TO THE INVENTION

Conventional commercial processes can typically be seen as a mixture of data processing stages or transactions on data accessed from data stores, and human actions such as a customer deciding which product to buy, and entering address and credit card details, or a human operator telephoning a supplier for example. Each data processing stage can involve a software program which queries a database. In a typical case, one stage could be concerned with taking customer orders, and could maintain a database of customer orders. A separate program could be responsible for issuing orders to suppliers, and could access the same database. There can be many stages in more complex processes. Problems can arise from errors in any program or in the data it needs. Despite many advances in software development, it is still impractical to test for correct operation in every set of circumstances. Also, in some cases, the performance of the process can be limited by the performance of the databases. There are a number of ways to address this, including providing upgraded hardware servers, or more servers, or by upgrading the database software for example or reorganisation of data and/or transactions.

Some of the issues and difficulties in designing and implementing mixed transactions are described in patent publication WO 0171621, such as coordination of computer resources necessary to implement even a single business process. In every large business, numerous incompatible computing platforms, operating systems, networking protocols, databases, and custom applications coexist. The various environments must be integrated in order to implement a new business process. In recent years, Message-Oriented-Middleware (MOM) products have been used to aid in the integration of disparate computing systems. Typically, such middleware products provide interfaces to applications by capturing, analyzing, and exchanging information via “events.” This mechanism allows business analysts to integrate many diverse application platforms to work together. While middleware products allow business applications to communicate together, they do not ease the task of automating new business processes. Middleware products do not allow for the reuse of business structure or business knowledge between applications. Instead, when such a business structure or knowledge must be reused, a new application must be created from scratch.

While middleware solutions cannot help when structures or knowledge must be reused, many businesses have turned to object-oriented development environments to meet this need. Since reusability is an important element in the object-oriented paradigm, this approach should allow new applications to be developed by reusing objects created in earlier applications. Unfortunately, because of the technical nature of object creation, definition, and refinement, many of reusability advantages of the object-oriented paradigm are inaccessible to the typical business process analyst. The solution proposed in the above mentioned patent publication is a set of tools that allow the graphical definition of top-down workflow process models. Once defined, these models are completely useable enterprise applications that can be deployed in real-time without interrupting current business operations.

Another example shown in U.S. Pat. No. 6,473,748 discusses a rule based or expert system approach using middleware such as CORBA software objects and an object request broker. Problems associated with implementing business rules for an enterprise include the following. For example, the human reasoning behind a rule, or the “essence” of the rule, is often changed in transitioning from human-oriented user requirements to actual software code. Another potential problem is that the same logical rules may be implemented in several different software applications in an inconsistent manner. When rules are implemented as software code, the identification of specific business rules within a software application, or across several software applications, is often difficult or impossible. The solution proposed is separating business rules from application logic. This architecture effects the implementation of software business rules in a single location, for sharing across software applications as needed. Software business rules are created and maintained by business experts directly, rather than requiring programmers to translate the rules to software code.

U.S. patent application 2003/0167194 shows a method of generating a process definition. It discusses workflow systems (i.e. process management packages) for controlling processes that are definable and governed by a series of policies and procedures, for example insurance claim processing, mortgage loan processing and engineering change orders. Workflow systems are based on procedure definitions that define which process activities must be performed and the sequence in which the activities must be performed. The procedure is defined using activity nodes connected via arcs, which represent activities of a process. Examples of activity node types are work nodes that typically perform, or initiate, a service and route nodes that are used to define the routing within the process. The activity nodes may incorporate rules that define entry conditions for the activity node and exit conditions that need to be checked after the activity node is completed. However, in practice a large number of aspects associated with businesses activities that are essential for a business solution escape a process-based formalisation. To counter this, the patent application proposes generating a process definition for execution by a process management system comprising a processor for generating a sequence of activities using information associated with messages exchanged between at least two business entities as part of a business process, wherein the sequence of activities correspond to the business process. It can involve monitoring messages exchanged between the at least two business entities.

It is known to address some types of software program “bugs” by using a language which is strongly typed. Type here means data type, such as integer, string or Boolean (base types), or compound types, i.e. combinations of base types. The language can effectively prevent inconsistencies by forcing the programmer to specify data types manually (eg Miranda), or by automatically inferring the data type (eg SML or Haskell). The process of inferring variables' types by looking at how they are used is called type inference. Type inference has a long tradition in functional languages. Hindley and Milner independently discovered a method for inferring types at compile-time. Its most widely-known incarnation is in the language ML. Another possibility is type inference at run-time.

Type inference in functional languages is based on work in the early 1960s on automatic theorem provers. In particular, an algorithm for unifying logical expressions (Robinson) was used later by Hindley and Milner. These type inference systems are conservative in the sense that, given a variable X, they will always compute a superset of X's type. Other computer languages including Algol-family languages for example, by comparison, have relied primarily on explicit type information supplied by the programmer, known as static typing.

Type inference has also been applied in the field of Pi calculus. Pi calculus is defined as a process algebra in which channel names can act both as transmission medium and as transmitted data. Its basic atomic actions are individual point to point communications which are nondeterministically selected and globally sequentialised.

It is known to use functional languages having type inference for programs used as stages in a commercial process. However, the benefit of the type inference is not carried beyond ensuring correct operation of that stage in isolation. Hence problems remain at the process level, problems such as mis-matches between stages, even if each stage is performing correctly as specified.

### SUMMARY OF THE INVENTION

It is an object of the invention to provide an improved program or an improved method or apparatus for the same.

A first aspect of the invention provides:

A computer program arranged to analyse a specification for a process, the process involving two or more autonomous computer programs, and involving processing of stored data, the specification specifying a data type for one or more interfaces of the process, the program being arranged to:
determine what kind of data processing operations are carried out within the process,
deduce automatically from the kind of internal operations, what data types are appropriate for inputs to or outputs of the operations, and
comparing the deduced data types with specified data types.

This can be seen as an extension of the known specialised programming technique of type inference for individual programs, into a new higher level technical field, of process analysis. This is potentially valuable in helping in checking such processes, in optimising them, in checking for consistency, between processes and external entities interfacing with the processes, in designing such processes, in optimising use of resources external to the process, and many other uses. In particular this can help in the common situation where coordination of different computer resources is necessary to implement even a single process. In practice there are often numerous incompatible computing platforms, operating systems, networking protocols, databases, and custom applications coexisting. Implementing processes in environments with many such incompatibilities, can be made easier by embodiments of the invention.

The term “process” is used here as encompassing commercial or technical processes or any other type of process. Commercial processes can encompass internet based trading of products or services, and financial information processing and so on. Technical processes can encompass control of any kind of physical systems, such as air traffic control, manufacturing process control, communications network management and so on.

The term “data type” is intended to encompass any categorisation or classification of information used at any kind of interface, as well as the conventional data types used for functional programming languages, as described above, including base and compound and other types. Data type can also encompass other properties of an object producing the data, for example an execution time limit for the object, or other general resource requirement of the object such as memory requirement, processor cycles, or communications bandwidth requirements or others. A consequence of this is that a designer can specify an overall execution time limit or overall resource limit and the design program can check if any objects will cause that to be exceeded.

The term “deducing automatically” is intended to encompass type inference by computer, and any other way of determining the data type.

Additional features, for dependent claims, include using the result of the comparison to check for errors, or to check for inconsistency in outputs of one of the stages. Other such additional features include checking one of the stages, then back propagate data type information derived from that stage for use in analysing one or more preceding stages. Another such feature is inferring a minimum set of data types usable by the stage. This can be useful in removing redundancy, if more than the minimum set are specified. Another such feature involves proposing additional or alternative predetermined stages based on deduced usable data types or which have suitable data types. This can help the designer to complete the process specification correctly and efficiently. Another such feature is using the result of the analysis to reduce coercion or push back such coercion towards inputs of a stage or the process or to alert a designer of the opportunity to do so. Another such feature is the process having a combination of automated and non automated steps. Another such feature is using the analysis for database optimisation to reduce load on dbase if that is a limiting factor. Another such feature is the process having steps for control of a physical system.

Another aspect of the invention provides:
a process specification which has been created using (optimised or checked by) the analysis program set out above.

This reflects that the commercial value may be greater in the output of the analysis program than the sale value of the analysis program itself.

Another aspect of the invention provides a method corresponding to the program.

Another aspect of the invention provides: a process template for application to various processes, the template having been created using (optimised or checked by) the analysis program set out above. Another aspect of the invention provides:
a computer program arranged to analyse a specification for a multi stage process, the process involving two or more autonomous computer programs, and involving processing of stored data, the program being arranged to:
determine what kind of internal operations are carried out within one or more of the stages,
deduce automatically from the kind of operations, what data types are appropriate for inputs to or outputs of the operations, and
use the data types deduced for one of the stages, to analyse another of the stages.

Another aspect of the invention provides:
a computer program arranged to analyse a process in use, to enable a specification for the process to be altered, the program being arranged to:
determine what kind of internal operations are carried out within the process as actually used, deduce automatically from the kind of operations, what data types are appropriate for inputs to or outputs of the operations, and
use the data types deduced for one stage, to analyse another of the stages.

Such analysis can encompass checking and optimising amongst others. This can be useful to check or optimise the process in use rather than that specified. This can be useful in various ways. For example, it may determine that users are entering data in different formats to those anticipated, or in different quantities, or that other aspects or the human interface are being used differently to the ways anticipated in the specification of the process. This element can use data type inference to check for any inconsistencies in the process as actually used, rather that the process as specified. The element can look at actual data, and assess the type of the actual data, rather than using the proposed data type of the specification.

Another aspect of the invention provides a method of offering a process analysis service using the program as set out above. This reflects that the services enabled by the use of the program could be more valuable than the sale value of the program itself.

Another aspect of the invention provides a computer program arranged to analyse a specification for a multi stage process, the process involving two or more autonomous computer programs, and involving processing of stored data, the program being arranged to determine a cost for a part of the process by determining what kinds of transactions are used in that part, and assigning a predetermined typical cost to each type of transaction. Such transactions can encompass phone calls, internet accesses, database accesses which are typically charged per transaction, fax communications, data processing transactions and so on. This can save a major part of the effort in building cost models for design analysis for processes, especially where there are large numbers of such transactions and of such types of transactions. The “predetermined typical cost” can be in the form of a value or an expression having one or more variables to be evaluated.

Other advantages will be apparent to those skilled in the art. The abovementioned optional features may be combined together or combined with any aspect of the invention.

### BRIEF DESCRIPTION OF THE DRAWINGS

Embodiments will now be described by way of example with reference to the drawings in which:

FIG. 1 shows a process design program according to an embodiment,

FIG. 2 shows a schematic view of a process having multiple stages and a number of data base accesses,

FIG. 3 shows a process design program according to another embodiment, and

FIG. 4 shows steps involved in designing stages of a process.

### DETAILED DESCRIPTION OF EMBODIMENTS

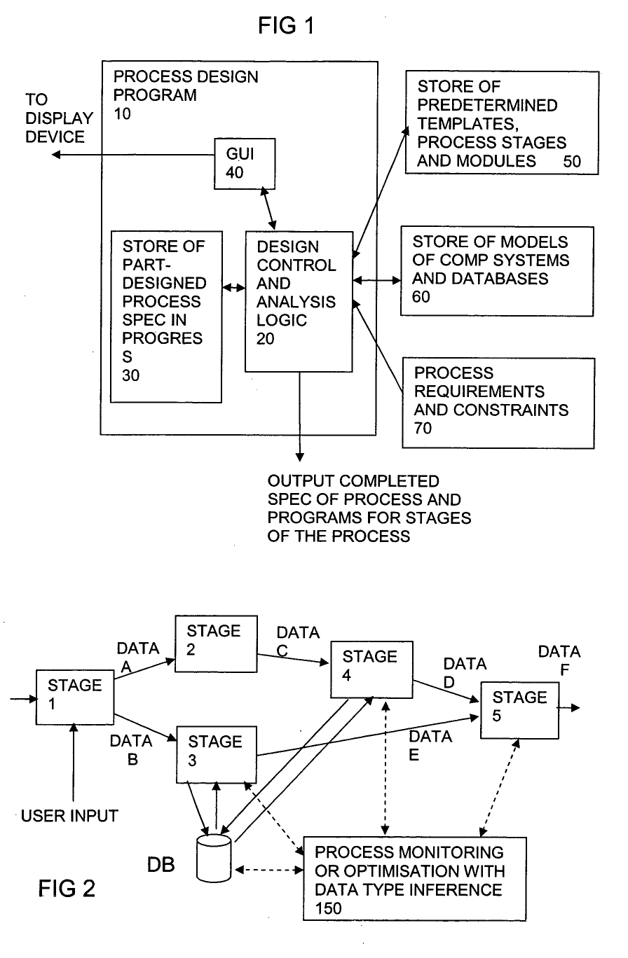

FIG. 1, Process Design Program

FIG. 1 shows in schematic form some of the principal elements of a process design program 10. It includes design control logic 20, a store 30 for storing a part-designed process specification, while it is in the process of being designed. The program interfaces to a store 50 of pre-determined process templates, pre-determined process stages, and pre-determined modules for building into processes. It also interfaces with a store 60 of models of underlying elements such as computer systems, communication systems and protocols, and data bases for example. The design control logic of the program also interfaces with process requirements and constraints 70. Typically the program interfaces with a human user through a GUI (graphical user interface) 40, which drives a display device.

The design control logic is arranged to follow instructions from the user to design the process, based on the process requirements and constraints. The design control logic is arranged to assist the user in a number of ways. Firstly it can aid the designer in producing a specification, by suggesting possible options which are available and consistent with the process requirements, and the part-completed specification. Secondly, the logic can analyse the specification or the part-completed specification, and check it for consistency, optimize the specification, to remove redundancies, to compress the specification, and to ensure interoperability with entities external to the process, such as underlying computer systems and communication systems, existing and new data bases, human interfaces for the process, and so on.

More specifically, the analysis can involve looking at what kind of data processing operations are carried out within the process as specified. The logic can then deduce automatically from the kind of internal operations, what data types are appropriate for input to, or outputs of, these operations. This can be achieved using techniques known for data type inference in the field of functional program languages. The inferred data types can be at various different levels of generality. The output of the inference can be specific data types such as integers or Boolean expressions, or strings, for example, or compound data types, having mixtures of these base types for example. Optionally, the output of the inference can be that the data type belongs to a class of data types, but is not known precisely. Further operations downstream in the process may enable the data type to become known more precisely. In such a case, when the data type inference is carried out for such a downstream stage of the process, the result can be “back-propagated” to the first mentioned stage. The result of this is that the precision of the inference can be improved, and whatever use is made of the output of the inference, can be repeated to improve the results.

The results of the inference can be used to compare the inferred data types with the data types specified in the specification, or the part-complete specification. If there are any inconsistencies, the control logic can be used to flag a potential error to the user through the GUI. Optionally, the data logic could be arranged to propose changes to correct the inconsistency, based on selecting from pre-determined modules or stages, which would be consistent in terms of the data types they use.

The control logic can also be arranged to look for non-optimal features in the process. These can include elements which are redundant, or which involve unnecessary coercion for example. Unnecessary coercion is defined as instances where data formats need to be converted unnecessarily, for example converting integers into long integers and back again for a logic test. A common case involves data entry in a format which needs to be changed every time the data is used. If the data type could be changed to a more suitable format at the outset, many unnecessary conversion processing steps can be removed. A simple example is storing a date as a string of text which must be re-parsed into data every time it is used.

The end result of the design process is an output from the design control logic which can include a completed specification of the process, and typically programs for stages of the process. The process design program can be implemented in any conventional software language running on conventional hardware such as workstations typically linked to file servers by a local area network. The format of the output will depend on the type of process and the environment for which it is designed. In the case of an example of an internet based product supply process, the specification could be in the form of a text document specifying programs, interfaces and data base accesses and human interfaces to customers and to staff of the organisation running the service. The text document could refer to programs or program modules written in conventional languages such as Java, weakly typed languages including C, or strongly typed functional languages such as “Miranda” or “Haskell” for example. Checking of the individual programs can be carried out using conventional techniques at compile time, including type inference techniques for example.

FIG. 2, Example of Process

FIG. 2 shows a process having a number of stages. Each stage involves processing data of some kind. Stage 1 involves inputs from a preceding process and user input, and produces two types of data, data A and data B. Data A in this example is fed to stage 2 for further processing, which produces data C. Data B is fed to stage 3 for further processing involving an access to a data base DB, and outputting data E. Stage 4 receives data C and carries out a data base access to data base DB and outputs data D. Stage 5 takes in data D and data E and outputs data F. A process monitoring or optimization element 150 is shown using data type inference as described above.

The different stages can involve computerised processing of data or manual or human processing of data, or a mixture. The data can represent almost anything, depending on the application of the process. One example might be processing an order for a product advertised on the internet. The user input could be an order for the product, together with a reference identifying the product, and an address and other details to enable payment and delivery. The various stages could make use of existing programs or procedures for arranging manufacture of the product or supply of parts for the product for example, or handling payment. The data base could be an inventory control data base, or a customer order data base for example, using conventional data base techniques. The data base could run on conventional servers, using a relational data base management system and query language such as SQL. The information input by the customer could include information such as address and postal code information. The data type of such a postal code could be considered as a compound data type including string types and integer types. This could be checked for consistency with the city field of the address for example, to ensure a correct postal code has been entered. It is much more efficient to catch errors such as incorrect postal codes at this early stage, rather than later in the process. The postal code information could be used at later stages in the process, for example in a program for arranging a delivery sequence or schedule. This could make use of existing programs for scheduling.

Such programs are likely to be written in a language incompatible with other programs in other stages. Nevertheless, it may be impractical to rewrite the functions of such existing programs, and therefore it is necessary to make use of them in the overall process. The designer of the process can use data type inference to check the overall operation of the process in many ways. For example, the scheduling program can be analysed to discover its internal operations, and determine how the postal code of the customer is processed. It may be processed as a single entity, or broken down into constituent parts for example. Knowing the data types of the inputs and outputs of such a scheduling program can enable the process designer to ensure that any inconsistencies are caught. For example, the data base may be constrained to treat the postal code as a single entity by existing programs.

During operation of the process, it will be become clear which of many possible paths in the process are actually being used, or overused. The process monitoring or optimisation element can be arranged to alter the process, or suggest alterations to a designer, depending on how the process is used. For example, it may determine that users are entering data in different formats to those anticipated, or in different quantities, or that other aspects or the human interface are being used differently to the ways anticipated in the specification of the process. This element can use data type inference to check for any inconsistencies in the process as actually used, rather that the process as specified. The element can look at actual data, and assess the type of the actual data, rather than using the proposed data type of the specification. Furthermore, this element can identify paths in the process which are never used, and can propose that these be removed, or altered to make them more useful for example. The most used paths in the specification can optionally be re optimised by the data type inference based techniques, at the expense of less used paths. Potential limitations such as processing delays or processing power of stages can be assessed based on real life information, rather than the estimates in the specification.

A relatively simple example of a process is a payment system. Three objects can be defined for each category of payment as follows, and these three objects are of type “payment”.
credit_card type payment
debit_card type payment
cash type payment

To design a business process a number of stages can be defined as follows.
present_goods
customer_choose
check_availability
pay
ship

These stages all have various types associated with them but only the payment type will be considered in more detail here in this example. Only three payment types are available and so the designer is presented with this high level function:
pay (choose: credit_card, debit_card, cash)

Credit_card and debit_card both have an additional parameter—authorisation, and again, authorisations are typed, as follows.
telephone_authorisation (type authorisation)
online_authorisation (type authorisation)

In other words this information is of type “authorisation”, and so if a specification for a process asks an end user to input this information as a preference, the specification should recognise the type and the process design program can check that the specification does not allow or perform an operation inappropriate to that type.

The process can include other branches of a decision tree—in this case a type based decision tree. For example a choice of cash payment requires a different parameter/resource:
received (type receipt)

The designer could specify that there are no further choices related to cash payment, or there may be no choice offered to the designer at this point. If there is only one object within our database, it gets automatically filled out in the specification.

At any point in the process, the designer can add new objects or remove objects and the type system of the process design program can use the type analysis to help a designer to create new processes, or correct existing processes more easily. The type analysis enables easier selection of functions than the known methods of searching large libraries of functions on the basis of names, looking for names that seem similar then looking in more detail at each function.

An example of a) is as follows. The designer removes the cash payment option by removing the received type. The type system of the process design program then identifies where the received type is used. It goes back up the decision tree of the specification, and determines that the cash type is dependent on the received type, and that the pay function uses the cash type. Hence it removes (or proposes to the designer to remove) the cash type and modifies (or proposes to modify) the pay function to limit to credit and debit card payment. The modification can include an appropriate advice message to users, for example “sorry we no longer accept cash payments because . . . .”

An example of b), a new object, is a new electronic payment system to a specified bank. The type system of the process design program can analyse the type of the new object and highlight to a designer that the new object is suitable to add as another payment option. If subsequently the new electronic payment system has to be withdrawn, the process design program can help manage the removal. It can identify which parts use this and can look for alternative objects having a data inputs or outputs having similar type.

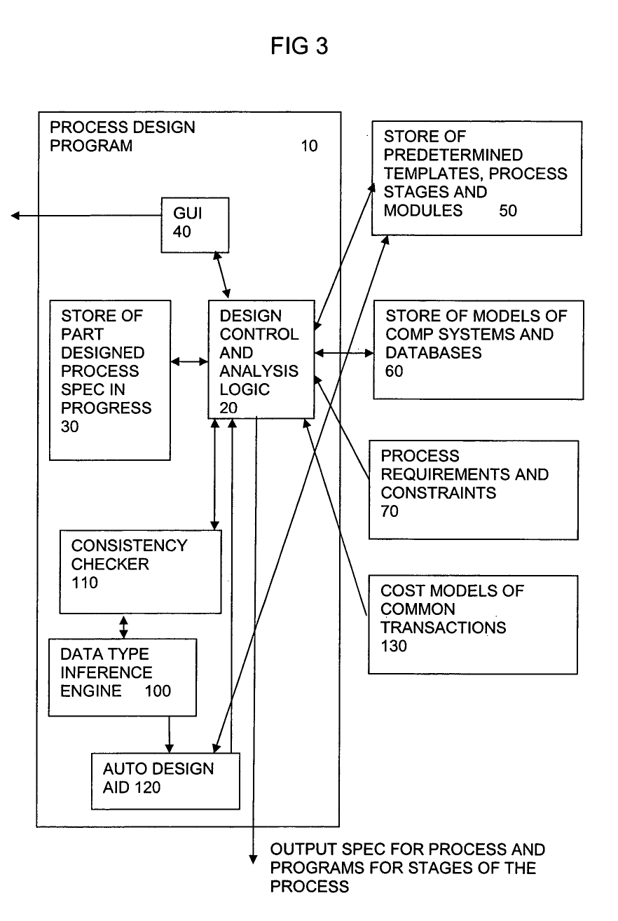

FIG. 3. Process Design Program

FIG. 3 shows another embodiment of a process design program. Similar reference numbers to those used in FIG. 1 have been used here. In addition, there is a data type inference engine 100, which feeds a consistency checker element 110, and an auto design aid element 120. Furthermore, there is additionally an external store 130 of cost models of common transactions.

The data type inference engine can operate as discussed above to infer data types of interfaces of processes or stages within a process, by examining the kind of internal operations carried out on the data, for example mathematical operations implies the data type cannot be a string. The consistency checker 110 is able to compare the inferred data types with data types specified. The result of the comparison is fed to the design control and analysis logic 20, to determine what action to take depending on whether the comparison is positive or negative, or partially consistent. In the latter case, there can be examples where the specified data type is one of a class of data types inferred by the inference engine for example.

The auto design aid 120 is able to use the outputs of the data type inference engine, and look in the store of predetermined stages and modules, for candidate stages or modules which could be used as a next stage in the design, if their data types are consistent. Suggestions which are consistent can be displayed to the user for selection, or can be further assessed automatically to rank them in order of likelihood of appropriateness for the specification in question.

The cost models store 130 is arranged to generate and store cost frames for a transaction from the medium that implements that transaction. This is to address the problem that costs of a complex transactional system may be difficult to specify where there are large numbers of cost types and cost amounts. If the media associated with a transaction is known, for example a data base, a phone call, a fax transmission, an internet access, then a cost value can be assigned automatically based on typical costs for that medium, without the additional effort or complication of determining individual costs for such transactions or slightly varying transactions many times over.

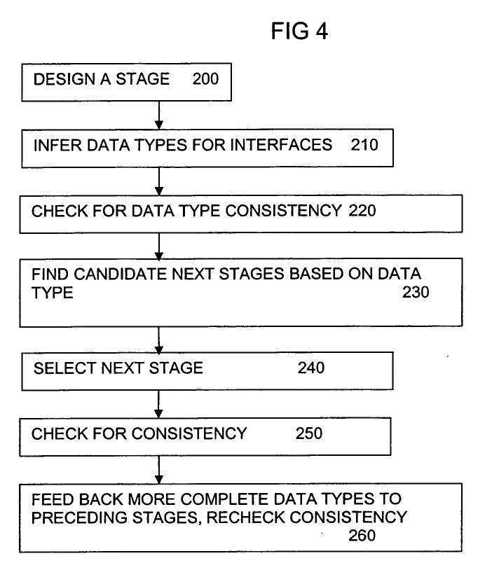

FIG. 4, Design Steps

FIG. 4 shows an example of some of the principal steps in a typical design process suitable for use in the design program of FIG. 3 for example. At step 200, a designer begins designing a stage, by inputting for example interfaces and processing operations carried out within the stage. This begins to create a part-complete specification. In the example of the payment stage discussed above with reference to FIG. 2, this could involve inputting objects for credit card, debit card and cash payment options, and their associated authorisation objects. The designer is usually a person, though in appropriate cases it might be an automated designer interacting with the process design program. At step 210 the data inference engine infers the data types for the interfaces of that stage automatically, based on information about the internal operations of that stage. In the payment example, this would correspond to inferring that data types of the inputs include a parameter indicating choice of payment, and in some cases, an authorisation, and that outputs can include an indication of a successful payment to trigger delivery for example. The system can infer the types of these inputs and outputs and use this analysis in various ways.

At step 220 the consistency checker checks for data type consistency between the specified data types and the inferred data types. If that does not raise any inconsistencies, the auto design aid element then finds candidate next stages or modules for next stages, at step 230. This can involve taking the inferred or specified data types, and looking for such next stages amongst the store of predetermined stages or modules, selecting only those which are consistent in terms of data types at their inputs and outputs. Consistency can mean using a specified data type amongst a class of allowed data types. In the payment example given above, this can involve checking that there is an input of some kind having type “authorisation”, and a mechanism for allowing a user to choose a payment method for example. The process design program can aid the selection of another stage or function making up a stage by searching for suitable stages or functions which have the appropriate type inputs or outputs. In the payment example this could mean searching for other objects that have an authorisation type input or a payment type output.

At step 240, the designer uses the GUI or text input for example, to select one of the candidate next stages. At step 250 this stage is checked for consistency as before. In some cases, at step 260 it will be possible to feed back more complete or more specific data types to preceding stages and enable the consistency to be rechecked. This is the back-propagation method described above.

The auto design aid element can also be used to check for redundancy in the entire process, and be used to compress the specification where possible. It can also be used to reduce coercion.

Applications and Other Remarks

The advantages discussed above can apply to any process, including processes which involve a mixture of automated and non-automated steps, mixtures of data processing data base access steps and human inputs. In principle it can apply to processes for controlling physical systems, or for processes relating to service delivery, including services of providing value added information from raw data.

Although the examples show a step of comparing inferred data types to specified data types, it is of course applicable also where data types are not specified, or are specified in less detail. The inference of data types can be carried out based on input and output events connected by a directed graph with functional nodes for example. Given type information at source and destination nodes of the internal operations, it is feasible to infer what the types of the intervening operations or functions must be from the interconnectivity. This enables a check that the connection pattern is correct.

Examples of implementation of the design program or programs making up the process can include program objects that can be invoked via different programmatic paradigms e. g. API (application program interface, CLI (command line interface) and others, and can be invoked on a variety of different platforms including, but not limited to, a JAVA platform, an XML platform, a COM (common object model) platform and an ODBC (open database connectivity) platform for example. Embodiments of the present invention can be implemented as a computer program product that includes a computer program mechanism embedded in a computer readable storage medium. For instance, the computer program product could contain program modules. These program modules may be stored on a CD-ROM, magnetic disk storage product, or any other computer readable data or program storage product. The software modules in the computer program product may also be distributed electronically, via the Internet or otherwise, by transmission of a computer data signal (in which the software modules are embedded) on a carrier wave.

The advantages can also be obtained by offering a process analysis service using the program, which could prove more valuable than selling the program or a system.

Above has been described a computer program for analysing a specification, determining what kind of data processing operations are carried out, and deducing or inferring from the kind of internal operations, what data types are appropriate. The data types inferred can be compared with specified data types, to check for errors, or optimise the overall process. This is effectively an extension of type inference from individual programs into the higher level technical field of process analysis. It can also be applied to monitoring and optimising processes during operation of the processes. Other variations and applications can be conceived by those skilled in the art which are intended to be within the scope of the claims.

1. A computer program arranged to analyse a specification for a process, the process involving two or more autonomous computer programs, and involving processing of stored data, the specification specifying a data type for one or more interfaces of the process, the program being arranged to:
determine what kind of data processing operations are carried out within the process,
deduce automatically from the kind of internal operations, what data types are appropriate for inputs to or outputs of the operations, and compare the deduced data types with specified data types.

2. The program of claim 1 arranged to use the result of the comparison to check for errors.

3. The program of claim 1 arranged to use the result of the comparison to check for inconsistency in outputs of one of the stages.

4. The program of claim 1 arranged to use the deduced data types from one of the stages for use in analysing one or more preceding stages.

5. The program of claim 1 arranged to deduce a minimum set of data types usable by a given one of the stages.

6. The program of claim 1 arranged to propose additional or alternative predetermined stages based on consistency of data types.

7. The program of claim 1 arranged to use the deduced data types to reduce coercion in the process.

8. The program of claim 1, for analysing a process having a combination of automated and non-automated steps.

9. The program of claim 1, for analysing a process having steps for control of a physical system.

10. The program of claim 1 arranged to use the analysis for optimisation of database accesses in the process.

11. A process specification which has been created using the analysis program of claim 1.

12. The process specification of claim 11 for a process having a combination of automated and non-automated steps.

13. The process specification of claim 11 for a process having steps for control of a physical system.

14. A method having the steps carried out by the program of claim 1.

15. A template for creating a specification for a process, the template comprising a partially complete specification created using the program set out claim 1.

16. A computer program arranged to analyse a specification for a multi stage process, the process involving two or more autonomous computer programs, and involving processing of stored data, the program being arranged to:
determine what kind of internal operations are carried out within one or more of the stages,
deduce automatically from the kind of operations, what data types are appropriate for inputs to or outputs of the operations, and
use the data types deduced for one of the stages, to analyse another of the stages.

17. A computer program arranged to analyse a process in use, to enable a specification for the process to be altered, the program being arranged to:
determine what kind of internal operations are carried out within the process as actually used,
deduce automatically from the kind of operations, what data types are appropriate for inputs to or outputs of the operations, and
use the data types deduced for one stage, to analyse another of the stages.

18. A computer system having a processor arranged to run the program of claim 1.

19. A method of offering a process analysis service for analysing processes using the program of claim 1.

20. A computer program arranged to analyse a specification for a multi stage process, the process involving two or more autonomous computer programs, and involving processing of stored data, the program being arranged to determine a cost for a part of the process by determining what kinds of transactions are used in that part, and assigning a predetermined typical cost to at least some of the types of transaction.
